(19) United States
(12) Patent Application Publication
(10) Pub. No.: US 2007/0073724 A1
(43) Pub. Date: Mar. 29, 2007

(54) System and method for automatic or semi-automatic software integration

(76) Inventor: Jeremy Walsh, Silver Spring, MD (US)

Correspondence Address: PILLSBURY WINTHROP SHAW PITTMAN, LLP, P.O. BOX 10500, MCLEAN, VA, 22102, US

(21) Appl. No.: 11/487,993

(22) Filed: Jul. 18, 2006

Related U.S. Application Data
(60) Provisional application No. 60/699,864, filed on Jul. 18, 2005.

(51) Int. Cl. G06F 17/30

(52) U.S. Cl. 707/10

(57) ABSTRACT

A system for software integration is described having a graphical interface portion with a first processor adapted to manage the software components resident within the system and a second processor, useable by a system administrator, that manages and deploys the system and its components. The system also includes a management services portion including a third processor adapted to provide security services by authenticating users, a fourth processor adapted to maintain the state and data model of the system, and a fifth processor adapted to manage integration between the system and an integrator. A back-end services portion is also provided that has a sixth processor adapted to manage the flow of data to and from tools, a tool manager adapted to manage the tools, and at least connection to at least one data source or destination.

### CROSS-REFERENCE TO RELATED APPLICATIONS

This application relies for priority on U.S. Provisional Patent Application Ser. No. 60/699,864, filed on Jul. 18, 2005. The provisional application is incorporated herein by reference in its entirety.

This application also is related to U.S. Patent Application Publication No. 2003/0233249 and U.S. Patent Application Publication No. 2005/0114201 by the same inventors. The contents of both applications are incorporated herein by reference in their entirety.

### BACKGROUND OF THE INVENTION

1. Field of the Invention

The present invention concerns a system and software that facilitates the integration of applications across one or more operating systems. More specifically, the present invention concerns a system and method at least partially for the automated integration of applications across one or more operating environments. Also, the present invention concerns a system and method for managing and controlling the integration of software.

2. Description of the Related Art

In the prior art, at the present time, in order to integrate applications into a particular operating environment, as would be appreciated by those skilled in the art, it is necessary to hire a consultant, also known as an “integrator.” An integrator has specialized knowledge about the integration of software on particular operating systems or platforms.

To integrate software, it is first necessary to develop the “specification” for the integration. The specification is the road-map or blueprint that sets the stage for the integration. Once the specification is developed, the integrator will ask the “client,” the party seeking the integration, to provide basic information about the client's system. The integrator will evaluate this information, in the context of the specialized knowledge that the integrator has, and begin the process of the integration.

Integration, however, is not a one step process in most instances. After positing a first round of questions, the integrator will often respond with one (or more often) a series of follow-up rounds of questions until the integrator exhausts all of the critical issues associated with the specification developed for the particular integration. Once the questions have been answered, the integration may be completed.

Due to the complexity of integration, the lack of management and control over integration generally, and the numerous possibilities for error, it has been noted that as much as 80% of integrations fail at least at one point or another. Such a high failure rate lengthens the time required for a successful integration. It also adds to the cost of integration.

As would be understood by those skilled in the art, the integration itself permits the client's system and existing software to “communicate” with the newly-added software. In some instances, this requires mapping calls within the system so that the system may access the software and data resident thereon. In other cases, for example, this may require the writing of new code so that the system may perform to expectations. The integrator may or may not be tasked with the writing of new code, depending upon the parameters of the employment of the integrator.

Regardless of the tasks asked of an integrator, the steps required to integrate new software into a system are entirely manual. Understandably, therefore, integration is a time-consuming process. Moreover, since integrators usually charge by the hours, the integration process also may be quite expensive, depending upon the complexity of the system being modified.

Also, once an integration is completed, the knowledge gained from the integration is lost. In other words, the client gains no knowledge of the particulars of the integration. Accordingly, when another integration is needed, the client has no option but to restart the process with a new integrator.

As would be appreciated by those skilled in the art, the current approach to integration is entirely manual, requiring human intervention. At present, software application integration involves, by and large, approaches involving manual processes.

It is, therefore, one deficiency in the prior art that software integration involves human manipulation. At least this deficiency in the prior art cries out for a solution.

### SUMMARY OF THE INVENTION

It is, therefore, one aspect of the present invention to provide an automatic, or at least semi-automatic, process for the integration of software into a system.

Another aspect of the present invention is to provide a process that reduces the amount of time needed to integrate software into an existing system.

Still another aspect of the present invention is a reduction (or elimination) of the time that an integrator needs to invest in a particular integration project.

Still another aspect of the present invention is a process that retains the “knowledge” obtained during an integration and retains that “knowledge” for future reference when software is to be integrated at a future date.

One further aspect of the present invention is the provision of a system and method that permits management of and control over the integration process.

One further aspect of the present invention is the provision of a semi automated/automated integrator that has the ability to communicate with existing applications for the exchange of code and data.

Still another aspect of the present invention provides for an integration to consist of N number of steps to complete, the steps being repeated until a successful integration is completed.

In accordance with the present invention, one aspect is to provide a system for software integration that includes a graphical interface portion resident on a processor and adapted to manage the software components resident within the system and manage and deploy the system and its components, a management services portion resident on the processor and adapted to provide security services by authenticating users, to maintain the state and data model of the system, and to manage integration between the system and an integrator, and a back-end services portion resident on the processor and adapted to manage the flow of data to and from tool implementations, the back-end service portion comprising a tool manager adapted to manage the tool implementations.

Still another aspect of the invention is to provide a system where the graphical interface portion is resident on a first processor that manages the software components resident within the system and that manages and deploys the system and its components, the management services portion is resident on a second processor that provides the security services to authenticate users, a third processor that maintains the state and data model of the system, and a fourth processor that manages integration between the system and the integrator, and the back-end services portion is resident on a fifth processor that manages the flow of data to and from the tool implementations.

One additional aspect of the present invention is to provide a system where the graphical interface portion also is resident on a processor other than the first processor.

Still another aspect of the present invention is to provide a system where the back-end services portion manages the flow of data to and from the tool implementations via the tool manager.

Another aspect of the present invention is to provide a system that also includes connections between the fifth processor and at least one data source and at least one data destination.

In another aspect of the present invention, a system is provided where the data source and the data destination are resident in the same memory device.

In still another aspect of the invention, a system is provided that also includes a connection between the first processor and the at least one of the second and third processors, a connection between the second processor and the third processor, a connection between the third processor and the fourth processor, and a connection between the third processor and the fifth processor.

It is yet another aspect of the present invention to provide a process for integrating software that includes creating a tool implementation through a graphical user interface, selecting configuration values required for generation of a code package for the tool implementation through the graphical user interface, generating the code package, providing the code package to an integration service provider, populating, by the integration service provider, the code package to obtain a populated code package, and returning the populated code package to the graphical user interface.

The present invention also includes as one of its aspects, the provision of a process where the code package is generated by a management service provider and is provided to the integration service provider by the management service provider, and wherein the populated code package is returned to the graphical user interface from the integration service provider via the management service provider.

In another aspect of the present invention, a process is provided that includes, after returning the populated code package to the graphical user interface, editing the configuration values required for generation of a tool package, providing the tool package to the integration service provider, populating, by the integration service provider, the tool package to obtain a populated tool package, and returning the populated tool package to the graphical user interface.

One further aspect of the present invention is to provide a process where the tool package is generated by a management service provider and is provided to the integration service provider by the management service provider, and wherein the populated tool package is returned to the graphical user interface from the integration service provider via the management service provider.

Another aspect of the present invention is to provide a process that includes, after returning the populated tool package to the graphical user interface, sending the populated tool package to a service agent provider, integrating the populated tool package on the service agent provider, generating results of the integration on the service agent provider, and returning the results of the integration to the graphical user interface.

The present invention also includes as one of its aspects, the provision of an iterative process for integrating software, comprising N number of iterations after creating and persisting a tool implementation, wherein each iteration of the N number of iterations includes editing configuration values for an integrator, persisting the configuration values for the integrator, validating the configuration values for the integrator, sending the configuration values to the integrator, at least one of validating, modifying, and populating the configuration values by the integrator, testing the configuration values to determine a success or failure of the integrator, and providing results of the testing for evaluation.

One further aspect of the present invention provides for an iterative process that also includes, after determining the success of the integrator, selecting service agent providers on which the tool implementation and configuration values are to be deployed, sending the tool implementation and configuration values to the service agent providers, integrating the tool implementation and configuration values on the service agent providers, persisting the results of the integration, and returning the results of the integration to the graphical user interface.

Still other aspects of the present invention will be made apparent from the description that follows and the drawings appended hereto.

### BRIEF DESCRIPTION OF THE DRAWINGS

The various embodiments of the present invention are described in connection with the figures appended hereto, in which:

FIG. 1 is a schematic illustration of the system of the present invention;

FIG. 2 illustrates one embodiment of a process of the present invention involving two iterations; and

FIG. 3 provides a flow chart that summarizes one possible organization for an integration process including an iterative portion involving N iterations.

### DETAILED DESCRIPTION OF EMBODIMENT(S) OF THE INVENTION

The three figures appended to this application illustrate various aspects of the invention including a system overview, an overview of a two-iteration process for automated software integration, and a process for automated software integration that involves N-number of iterations, where N is a positive integer of 1 or greater.

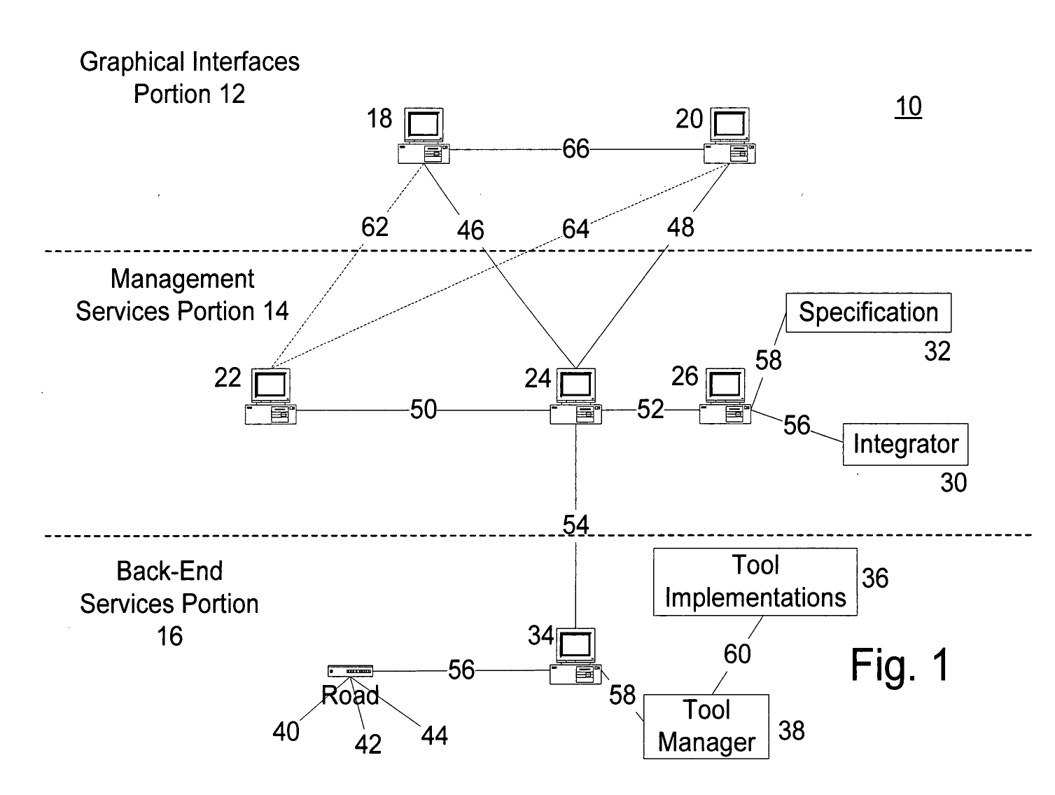

The system 10 of the present invention is illustrated in FIG. 1. The system 10 includes three different portions, a graphical interface(s) portion 12, a management service(s) portion 14, and a back-end service(s) portion 16. The three portions may involve more than one computer or processor or may be used to define different functionalities available on a single computer or processor. These three portions and their components are meant to be illustrative only of one possible embodiment of the present invention. As would be appreciated by those skilled in the art, the system many include “n” portions, where “n” is a positive integer. Moreover, there may be “n” components. Still further, all of the portions and their components may be embodied in a single machine or processor.

The graphical interface portion 12 of the system 10 includes at least one processor (or computer). In FIG. 1, two processors are illustrated. The first processor is referred to as the “Graphical User Interface” machine 18. The Graphical User Interface machine 18 is used to manage the software components resident on a client system. The Graphical User Interface machine also is used to manage the lifecycles of the software components within its control. As illustrated, the second processor 20 is used by administrators to manage and deploy the software and process(es) described herein. The other Graphical User Interface machine 20 also is responsible for managing and deploying components of the software and process(es) described herein.

As would be appreciated by those skilled in the art, the functionality of the two processors 18, 20 may be integrated into a single machine 18. Where only one processor is employed, the Graphical User Interface machine 18 is used to manage the software components resident on a client system, to manage the lifecycles of the software components within its control, and to manage and deploy the software and process(es) described herein. The Graphical User Interface machine 18 also is responsible for managing and deploying components of the software and process(es) described herein.

The management services portion 14 of the system 10 of the present invention also includes at least one processor. FIG. 1 illustrates three processors, by way of example. However, as would be appreciated by those skilled in the art, the management services portion 14 is not limited to three processors. As would be appreciated by those skilled in the art, a larger or fewer number may be employed without departing from the scope and spirit of the present invention.

In the illustrated embodiment, the first processor is referred to as the “Security Service” machine 22. The Security Service machine 22 is responsible for security services. In particular, the Security Service machine is a security authenticator that authenticates users with existing security systems. The second processor is referred to as the “Management Service” machine 24. The Management Service machine 24 maintains the state and data model of the software of the present system. The third processor is referred to as the “Integration Service” machine 26. The Integration Service machine is responsible for managing the integration between the Management Service machine 24 and the integrator 30. As would be appreciated by those skilled in the art, the integrator 30 may include one or more integrators 30.

The specification 32 is also illustrated as a part of the management services portion 14 of the system 10 of the present invention. As would be appreciated by those skilled in the art, the specification 32 includes, but is not limited to, the specification for the system 10 or one or more of the processors within the system 10. In addition, the specification 32 may include various parameters, data, settings, configurations, etc. that are needed to implement a particular integration. The specification 32 may also refer to the “outline” or the high level picture associated with a particular integration.

In the illustrated embodiment, the back-end services portion 16 of the system 10 includes three parts. The first part is the processor referred to as the “Service Agent” machine 34. The Service Agent machine is responsible for managing the work flow of data to and from tool implementations 36 within the control of the Tool Manager 38. The Service Agent machine 34 is the machine or processor on which the integration will ultimately be implemented. The Service Agent machine 34 is connected to a number of “roads” 40, 42, 44. The roads 40, 42, 44 lead to and from various data sources and destinations, which will not be described further as they would be understood to those skilled in the art. A road 40, 42, 44 is merely a connection to another machine or data storage device, for example. It may also be a connection to the Internet, as necessary. As would be appreciated by those skilled in the art, the back-end services portion 16 may include a fewer or greater number of components.

As would be appreciated by those skilled in the art, the Tool Manager 38 may be a library designed to house a number of Tool Implementations 36 therein. In such an instance, the Tool Manager 38 organizes the Tool Implementations 36 in any suitable arrangement so that the Tool Implementations 36 may be located, identified, and used, as needed.

It is noted that the graphical interfaces portion 12, the management services portion 14, and the back-end services portion 16 illustrated in FIG. 1 are presented merely for discussion purposes and are not required to be defined in this manner to practice the present invention. The arrangement provided is presented merely to facilitate discussion of the present invention. As noted above, the present invention could be practiced on a single processor, thereby eliminating all of the additional components illustrated in FIG. 1. In other words, the six processors 18, 20, 22, 24, 26, and 34 may all have their associated functionality resident on a single processor. With such a construction, the three portions 12, 14, and 16 would all be resident on the same processor or machine.

Before describing the system 10 in greater detail, various of the connections between the components of the system 10 will now be described with reference to FIG. 1. The Graphical User Interface machine 18 and the second Graphical User Interface machine 20 are connected to the Management Service machine 24 via connections 46, 48. The Management Service machine 24 is connected, in turn, to the Security Service machine 22 and the Integration Service machine 26 via connections 50, 52. The Management Service machine 24 is also connected to the Service Agent machine 34 via connection 54. In the instance where the Graphical User Interface machine 18 and the second processor are integrally formed as a single processor, the Graphical User Interface machine 18 is connected to the Management Service machine via the connection 46. Without the second processor 20, the connection 48 may be eliminated.

The Integration Service machine 26 is shown connected to the integrator 30 and the specification 32 via connections 56, 58. These are not truly connections, but are merely illustrative of one possible interaction between the system 10 and the specification 32 and the integrator 30. As would be appreciated by those skilled in the art, after the integration is complete, the integrator 30 and the specification 32 are no longer required and, therefore, are not relied upon for operation of the system 10.

It is noted that the end result of the integration by the integrator 30 is the Tool Manager 38 (or some portion of the Tool Manager 38). Accordingly, after the integration is completed, the “knowledge” gained by the integration is incorporated into the Tool Manager 38 for use in the future.

Via connection 56, the Service Agent machine 34 is connected to various “roads” 40, 42, 44, which are connections to data sources and destinations. The Service Agent machine 34 also is connected to the Tool Manager 38, via connection 58. In turn, the Tool Manager 38 is connected to the tool implementations 36 via connection 60. As with the Integration Service machine 26, the connections 58, 60 need not be actual connections. Since the Tool Manager 38 and the Tool Implementations 36 typically are both resident on the Service Agent machine 34, the connections 58, 60 are internal to that machine and are merely illustrative of the interaction of the Tool Manager 38 and the Tool Implementations 36 on the Service Agent machine 34.

In addition, in the system 10, the Security Service machine 22 may be intermittently connected to the Graphical User Interface machine 18 and the second processor 20 via connections 62, 64. This makes sense since the Security Service machine 22 is the security processor for the system 10 and, therefore, validates security protocols for the other machines that are connected to the system 10. It is noted that the Graphical User Interface machine 18 and the second processor 20 may be connected to one another via a connection 66. Of course, where the second processor 20 is not included in the system 10, the connection 66 is not required.

With respect to these connections, those skilled in art will readily recognize that the connections may be wired or wireless. Moreover, the connections are not intended to be restrictive of the only connections possible for operation of the system 10 of the present invention. As would be appreciated by those skilled in the art, FIG. 1 merely present one possible embodiment of the system of the present invention 10. Other connections between the various components of the system 10 may be made without departing from the scope of the present invention, as would be understood by those skilled in the art.

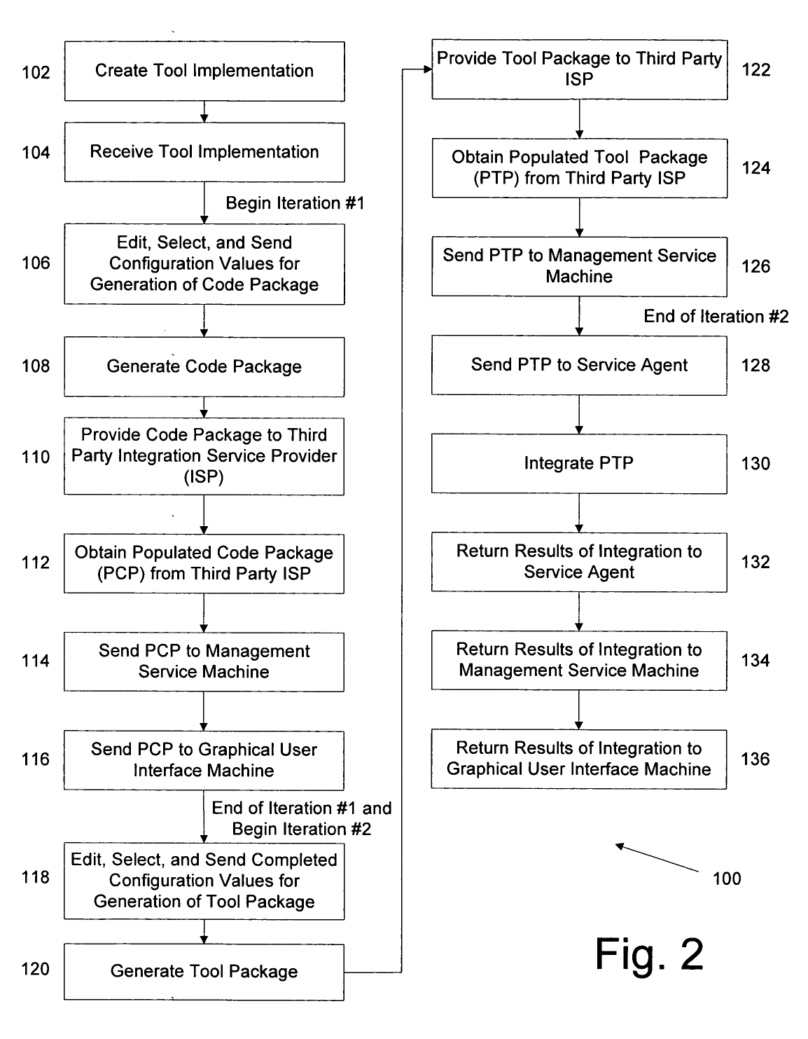

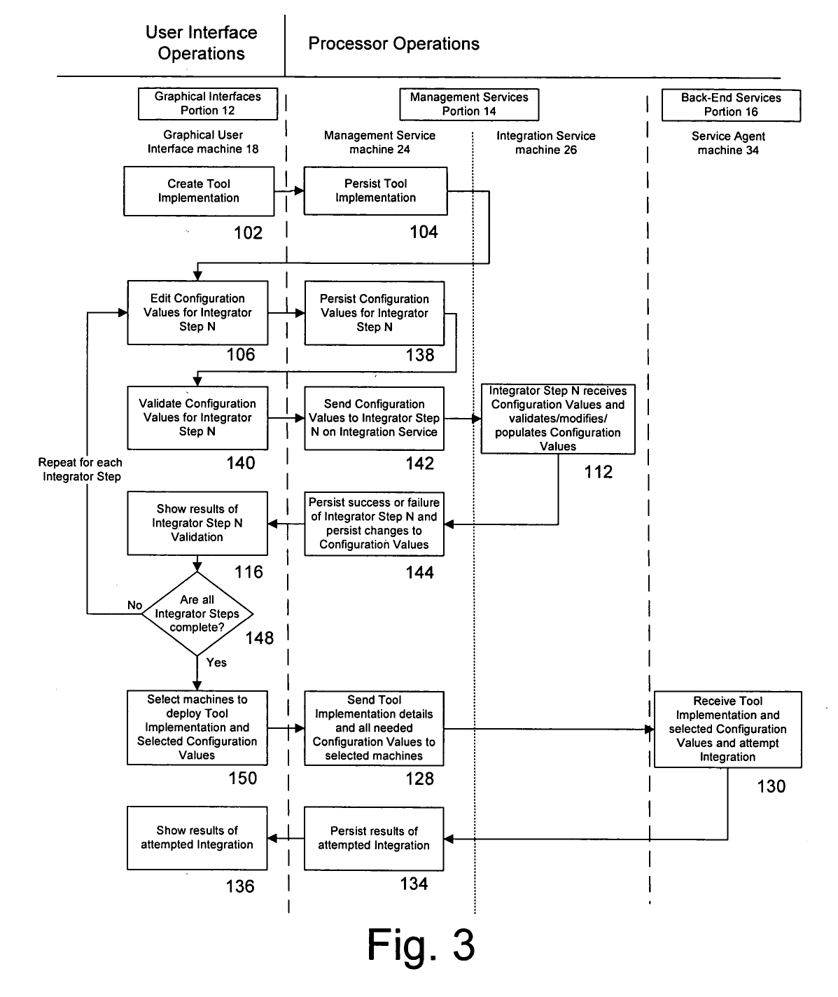

The process if automatic or semi-automatic integration will now be described in connection with FIG. 2. It is noted that FIG. 2 illustrates a process with two iterative steps, or two iterations. As would be appreciated by those skilled in the art, the process may include “N” iterative steps, where “N” may be any positive integer. That process is discussed in connection with FIG. 3, below.

The integration process 100 begins at 102 where a tool implementation is created. This occurs at the GUI machine 18. Typically, a user will define an object, into which information will be placed, during the generation of the tool implementation. The object may also be considered to be a “container,” data file, or root that will be created and modified during the integration process to result in a successfully-operational tool implementation 36 on the system 10. As would be appreciated by those skilled in the art, the creation of the tool implementation 36 also refers to the creation of the specification 32 for the system 10. The creation of a tool implementation 102 is not limited to the creation of any specific tool implementation 36, as would be understood by those skilled in the art. A tool implementation 36 is meant to refer to any segment of code (or software) or any application (i.e., Word® for Windows®) that performs a function. The function could be to manipulate data, but this is not required for operation of the system 10 or the process 100 of the present invention. Tool Implementations 36 are managed by the Tool Manager 38. The tool implementations 36 may be resident on a particular processor, computer, or system or they may be remotely located from the system 10 but made available to the system 10.

In the case of the integration of a new software application (i.e., a new software program) into the system 10, the specification 32 refers to the tool implementation 36 needed to perform the integration of the software into the system 10. The tool implementation 36 may include any number of items, including among them specific calls needed to access data files and executable programs resident on the system 10. The tool implementation 36 also may require the generation of code so that applications and data files may be accessible after the integration is complete. The tool implementation 36 also may include instructions for renaming files that have duplicative names, for example and providing the instructional road map so that these various items may be accessed and used. All of these aspects would be known to those skilled in the art and are, therefore, not elaborated upon further.

After the tool implementation has been created 102, the tool implementation is received at 104 by the Management Service machine 24, which passes the tool implementation to the Integration Service Machine 26. From the system 10 perspective, the tool implementation 36 is received at the Integration Service machine 26. From 104, selected configuration values required for generation of the tool implementation 36 are sent at 106. In the context of the system 10, this means that the Graphical User Interface machine 18 will provide the Integration Service machine 26 with values that are needed for the integration to proceed. Then, the required code package is generated at 108.

For purposes of 106, it should be understood that the configuration values are selected, edited, and sent by a user operating the GUI machine 18. The user typically selects the configuration values needed to generate the required code package (at 108). Of course, as also should be appreciated by those skilled in the art, the editing, selection, and sending of the configuration values required for generation of the code package may be performed automatically by the GUI machine 18 or other processor.

The required code package is generated by the Management Service machine 24. Alternatively, however, a combination of the Management Service machine 24 and other machines within the system 10 may cooperate to generate the required code package. In one example, the required code package may be generated by the Integration Service machine 26 or a combination of the Management Service machine and the Integration Service machine 26.

Once the required code package is generated at 108, the code package is provided to a third party Integration Service Provider (“ISP”) (the Integration Service machine 26) at 110. From the system perspective, this means that the Management Service machine 24 provides the code package to the Integration Service machine 26. Alternatively, this also may refer to the provision of the required code package to the integrator 30 from the Integration Service machine 26. The third party ISP (the Integration Service machine 26) populates a code package (called a “Populated Code Package” or “PCP”), which is obtained by the system 10 from the third party ISP 26 at 112. Practically speaking, the PCP is received by the Integration Service machine 26. The PCP is then sent to the Management Service machine 24 and the Graphical User Interface machine 18 at 114 and 116. The PCP is used by the Management Service machine 24 and the Graphical User Interface machine 18 to create the completed configuration values. Completed configuration values are then sent at 118. The PCP results from the operation of the Integration Service machine 26 on the required code package. The PCP includes information, configuration information, settings, data, etc. that are provided by the integrator 30. The PCP is then sent from the Integration Service machine 26 back to the Management Service machine 24 at 114. From the Management Service machine 24, the PCP is returned to the GUI machine 18, in 116.

It is noted that each of the manipulations 106, 108, 110, 112, 114, and 116 are considered to be part of a first iteration in the integration process. A second iteration, encompassing the manipulations 118, 120, 122, 124, and 126, typically will follow the first iteration. As would be appreciated by those skilled in the art, however, it is possible that the first iteration may be all that is required for a successful integration.

In the second iteration, from 118, a request is made to create a tool package at 120. The integration package is then provided to the third party ISP (the Integration Service machine 26 with the Integrator 30) at 122. From there, the third party ISP populates the tool package (referred to as the “Populated Tool Package” or “PTP”), which PTP is obtained by the system 10 at 124. The PTP is then sent to the Management Service machine 24 and the Graphical User Interface machine 18 at 126.

It is noted that this second iteration is similar to the first iteration in that the same components of the system 10 are employed to obtain the PTP from the integrator 30. The PCP and the PTP differ from one another in that the user has modified the configuration values in 118, thereby modifying the configuration values that are the basis for the creation of the tool implementation 36. As discussed above, it is expected that at least one modification, selection, or editing will be required by the user after the creation of the PCP before creation of the PTP. It is for this reason that a two-iteration process is believed to be likely in most instances of the application of the present invention to software integration.

As for 128, here the PTP is forwarded to the Service Agent machine 34 by the Management Service machine 24. The PTP is forwarded to the Service Agent machine 34 for purposes of integrating the PTP on the Service Agent machine 34.

The PTP may then be integrated into the system 10 as shown at 130. Once the integration is made, the system 10 validates the integration and returns a result of the integration to a service, listed as the Service Agent in FIG. 1. This occurs at 132. The results of the integration are then returned to the Management Service machine 24 at 134. The results of the integration are also returned to the Graphical User Interface machine 18 at 136. At the conclusion of 136, if the integration is successful, no further action is required.

As will be appreciated by those skilled in the art, this process may be performed automatically or semi-automatically to speed up the integration process. A majority of time is spent by human integrators in the validation of files, executables, and calls thereto. The present invention eliminates, or at least minimizes, human interaction by automatically validating the integration. Accordingly, in most cases the entire integration may be automatically completed. In some instances, there may be questions that remain that will require human interaction. It is for this reason that the system and method of the present invention may be considered by some to be semi-automatic. The system and method of the present invention will complete as much of the integration as needed before referring to a human to resolve additional questions. In other words, the present invention is designed to produce at least one of two responses from the integrator, a completion result or a request for a new set of requirements (or additional information). Other possibilities also exist, as would be appreciated by those skilled in the art.

One aspect of the invention that is particularly helpful to the client is that the integration itself will generate a tool that is useable by the system 10. In other words the aspects of the integration become a tool that the system 10 may use again in the future for any subsequent integration. This is a radical departure from the practice in the prior art where the “knowledge” that is gained through the integration is lost after the integration is completed.

One way in which the system and method of the present invention make possible automated integration lies in the fact that the system recognizes the tags and metatags in xml files that require a “connection” so that the applications (the various programs resident on the system) may interact with one another. Of course, as would be appreciated by those skilled in the art, the present invention is not limited to xml text or formats but may be employed in any language format. Moreover, the present invention may be employed on a bit or byte level, as selected by the system owner and/or user.

When integrating software into a particular platform, the system 10 of the present invention locates input an output “connectors” associated with the new software to be added to the platform. Once the connectors are identified (i.e., by a tag or metatag), the system 10 of the present invention connects those connectors to associated connection points that are compatible. In this manner, the new software may be integrated in to a platform in an automated fashion.

If the system 10 of the present invention does not recognize one or more connectors, the integration will not be successful. In this particular instance, the system 10 will return the results of the integration (i.e., at 132). The results will include a “failure” report to fully integrate the software and provide an identification of those connection that could not be made. In this respect, it is noted that the results of the integration most often will include either a request for addition information or confirmation that the integration (or part of the integration) was successful.

One aspect of the present invention is that the time (and cost) associated with an integration may be greatly reduced. For example, assume that a company wishes to integrate new software into a complex platform. Assume also that the system requires 100,000connections to be made to properly integrate the new software into the platform.

To make the integration today, a team of computer specialists would be required to make the connections manually. The present invention is designed to make all (or most) of these connections without human interaction. Accordingly, if the present invention can reduce the number of connections that must be made by a human to 1,000 of the 100,000, the time to integrate the new software into the platform is reduced to 1% of the time previously required.

Other aspects of the present invention will be made apparent from the drawings appended hereto and the totality of the description provided herein. The invention is expressly not limited to any one embodiment described herein but is intended to encompass any equivalents to the embodiments described herein.

Another approach of the present invention is to allow for there to be N number of iterations by an integrator 30 before attempting an integration to a Tool Manager 38. This provides for the ability of the integrator 30 to query the user that is selecting the configuration values as many times as needed so that they can assure that all the information that is required for a successful integration is provided. This iterative process is illustrated by FIG. 3 and is discussed in greater detail below.

Furthermore, it is within the scope of the present invention that the integrator 30 has the ability to query other machines based on the information provided in the configuration values. An example of this would be if the integrator 30 required verification that a specific application did indeed exist on a specific machine. To make this verification, the integrator 30 generates an information signal to query that machine for information on the application could be provided as configuration values. Once the integrator 30 receives the configuration values, the integrator 30 sends a TCP/IP request to the machine and awaits a specific response from the machine that provides information on the existing applications on that machine. Therefore, as would be appreciated by those skilled in the art, the integrator 30 is not limited in it's ability to gather or act upon data obtained from one or more other machines.

In connection with the present invention, the Tool Manager 38 is a unit of software code that manages and invokes (executes) other components or software applications. A Java Virtual Machine is an example of a type of the Tool Manager 38. A Java Virtual Machine takes java classes and converts the interpreted code into machine executable statements. Thus, without any java classes the Java Virtual Machine could not function. The same is true for the Tool Manager 38. Without tool implementations 36, the Tool Manager 38 cannot function. However, the purpose of the Java class and the tool implementation are exactly the same. They are meant to be taken an executed, the Java class via a Java Virtual Machine and a tool implementation via a Tool Manager, which may also be a Java Virtual Machine.

As illustrated in FIG. 3, the operation of the Graphical User Interface portion 12, the Management Service portion 14, and the Back-End Service portion 16 are illustrated in connection with the various steps of the second embodiment of the present invention.

As in the first embodiment, the process begins at 102 with the creation of a tool implementation a the GUI machine 18, just as illustrated in FIG. 2. From 102, the process proceed to 138 where the tool implementation is “persisted.” The term “persist” should be readily understandable to those skilled in the art. The term is intended to refer to the saving of information is some fashion (i.e., by saving to a disk or memory, for example) such that the information is later retrievable. Therefore, the term “persist” tool implementation is intended to convey that the tool implementation is retained by the system 10 such that further aspects of the process may be performed.

It is noted that, where applicable, the same reference numbers employed in FIG. 2 are employed in FIG. 3. The layout of FIG. 3 differs slightly from that of FIG. 2 in that the likely locations in the system 10 where the operations are being performed are identified to assist with an understanding of the present invention.

After the tool implementation is persisted at 138, the configuration values for the tool implementation are edited, typically by a user at the GUI machine 18. This occurs at 106. Here, the user evaluates the configuration values for the tool implementation and selects those values that are required to proceed with the integration (or with the generation of the tool implementation 36). After the configuration values are edited at 106, the process proceeds to 140 where the configuration values are persisted. In this step, the Management Service machine 24 may modify the configuration values by adding values or by substituting values as are needed for the tool implementation 36. From 140, the process proceeds to 142, where the user validates the configuration values as modified or edited by the Management Service machine 24. Once validated, edited, or modified by the user at the GUI interface 18, the process proceed to 144, where the configuration values are sent by the Management Service machine 24 to the Integration Service machine 26.

At 144, the configuration values are received by the Management Service machine 24 and are then sent to the Integration Service machine 26. At 112, the Integration Service machine 26 receives the configuration values and validates, modifies, or populates the configuration values with data or information required to complete the integration by creating the tool implementation 36. From 112, the process proceeds to 146 where the Management Service machine 24 persists the success or failure of the integrator 30 and persists whatever changes have been made to the configuration values. The process then proceed to 116, where the success or failure of the integrator 30 are displayed on the GUI machine 18.

The process proceeds next to 148, where an evaluation is made to assess if all of the integration steps are complete. In other words, an assessment is made to determine if there is a need for further iterations N before the integration may be completed. If all of the steps are not complete (usually meaning that the integration was unsuccessful), the process returns to 106 and the iteration is repeated until all of the integration steps are completed.

Once all of the integration steps are completed, the process proceeds to 150 where the machines on which the tool implementation 36 is to be integrated is selected. At 128, as discussed above, the details and configuration values required to implement the tool implementation 36 on the selected machines is forwarded to the Management Service machine 24. The tool implementation 36 is then sent to and received by the Service Agent machine 34, where the integration is attempted. The results of the integration are then persisted at 134 and returned to the GUI machine 18 at 136.

For purposes of understanding that present invention, it is noted that a configuration value is a type of property that holds data. In one embodiment the configuration value might be a file. In another embodiment the configuration value might be a property that the user selects from a list of possible properties. In yet another embodiment the configuration value might be a property that the user enters, such as a character string or numeric value. These are examples of types configuration values and are not meant to be all encompassing.

In addition, the term “machine” as used in connection with the Management Service machine 24 should not be understood to refer to a particular processor or machine. Instead, the term “machine” may be used interchangeably with “provider” as needed to facilitate an understanding of the invention. The term “provider” is intended to be more broad than the term “machine” for purposes of the claims appended hereto.

Other processes are possible and the process illustrated in FIG. 3 is but one contemplated embodiment.

As would be appreciated by those skilled in the art, the embodiments described herein are not meant to be limiting of the present invention. Other embodiments are contemplated to fall within the scope of the invention and are intended to be so encompassed.

What is claimed is:

1. A system for software integration, comprising:
a graphical interface portion resident on a processor and adapted to manage the software components resident within the system and manage and deploy the system and its components;
a management services portion resident on the processor and adapted to provide security services by authenticating users, to maintain the state and data model of the system, and to manage integration between the system and an integrator; and
a back-end services portion resident on the processor and adapted to manage the flow of data to and from tool implementations, the back-end service portion comprising a tool manager adapted to manage the tool implementations.

2. The system of claim 1, wherein:
the graphical interface portion is resident on a first processor that manages the software components resident within the system and that manages and deploys the system and its components;
the management services portion is resident on
a second processor that provides the security services to authenticate users,
a third processor that maintains the state and data model of the system, and
a fourth processor that manages integration between the system and the integrator; and
the back-end services portion is resident on a fifth processor that manages the flow of data to and from the tool implementations.

3. The system of claim 2, wherein the graphical interface portion also is resident on a processor other than the first processor.

4. The system of claim 2, wherein the back-end services portion manages the flow of data to and from the tool implementations via the tool manager.

5. The system of claim 2, further comprising connections between the fifth processor and at least one data source and at least one data destination.

6. The system of claim 5, wherein the data source and the data destination are resident in the same memory device.

7. The system of claim 2, further comprising a connection between the first processor and the at least one of the second and third processors, a connection between the second processor and the third processor, a connection between the third processor and the fourth processor, and a connection between the third processor and the fifth processor.

8. A process for integrating software, comprising:
creating a tool implementation through a graphical user interface;
selecting configuration values required for generation of a code package for the tool implementation through the graphical user interface;
generating the code package;
providing the code package to an integration service provider;
populating, by the integration service provider, the code package to obtain a populated code package; and
returning the populated code package to the graphical user interface.

9. The process of claim 8, wherein the code package is generated by a management service provider and is provided to the integration service provider by the management service provider, and wherein the populated code package is returned to the graphical user interface from the integration service provider via the management service provider.

10. The process of claim 8, further comprising:
after returning the populated code package to the graphical user interface, editing the configuration values required for generation of a tool package;
providing the tool package to the integration service provider;
populating, by the integration service provider, the tool package to obtain a populated tool package; and
returning the populated tool package to the graphical user interface.

11. The process of claim 9, wherein the tool package is generated by a management service provider and is provided to the integration service provider by the management service provider, and wherein the populated tool package is returned to the graphical user interface from the integration service provider via the management service provider.

12. The process of claim 9, further comprising:
after returning the populated tool package to the graphical user interface, sending the populated tool package to a service agent provider;
integrating the populated tool package on the service agent provider;
generating results of the integration on the service agent provider; and
returning the results of the integration to the graphical user interface.

13. An iterative process for integrating software, comprising N number of iterations after creating and persisting a tool implementation, wherein each iteration of the N number of iterations comprises:
editing configuration values for an integrator;
persisting the configuration values for the integrator;
validating the configuration values for the integrator;
sending the configuration values to the integrator;
at least one of validating, modifying, and populating the configuration values by the integrator;
testing the configuration values to determine a success or failure of the integrator; and
providing results of the testing for evaluation.

14. The iterative process of claim 13, further comprising:
after determining the success of the integrator, selecting service agent providers on which the tool implementation and configuration values are to be deployed;
sending the tool implementation and configuration values to the service agent providers;
integrating the tool implementation and configuration values on the service agent providers;
persisting the results of the integration; and
returning the results of the integration to the graphical user interface.
